(19) United States
(12) Patent Application Publication
(10) Pub. No.: US 2006/0040644 A1
(43) Pub. Date: Feb. 23, 2006

(54) SYSTEM AND METHOD FOR SENDING PHOTOS TO DEFAULT SEND-TO RECIPIENT FOR MOBILE TELEPHONE MESSAGING

(75) Inventors: Benjamin K. GIBBS, Camas, WA (US); Atsushi ISHII, Vancouver, WA (US); Richard Eric HELVICK, Portland, OR (US)

Correspondence Address: SHARP LABORATORIES OF AMERICA, INC, 5750 NW PACIFIC RIM BLVD, CAMAS, WA, 98642, US

(73) Assignee: SHARP LABORATORIES OF AMERICA, INC., Camas, WA (US)

(21) Appl. No.: 10/908,097

(22) Filed: Apr. 27, 2005

Related U.S. Application Data
(60) Provisional application No. 60/602,370, filed on Aug. 17, 2004.
(60) Provisional application No. 60/603,032, filed on Aug. 19, 2004.

(51) Int. Cl. H04Q 7/20

(52) U.S. Cl. 455/412.1; 455/466

(57) ABSTRACT

A default recipient of a message and/or photograph sent from a mobile camera telephone is determined based on one of several alternative techniques. In one technique, the default recipient could be a preselected default recipient. In another alternative technique, the default recipient could be determined based on a most recent recipient of another message and/or photograph. As yet another alternative technique, the default recipient could be determined based on a recipient contained in a send-to list that has received a most number of messages and/or photographs. Still another alternative provides that the default recipient is determined in response to actuation of a selected key of the mobile telephone that corresponds to the default recipient.

### CROSS-REFERENCE TO RELATED APPLICATIONS

The present application claims priority to commonly owned U.S. Provisional Patent Application Ser. No. 60/603,032, filed Aug. 19, 2004, entitled “System and Method For Sending Photos To Default Send-To Recipient For Mobile Telephone Messaging,” invented by Benjamin K. Gibbs et al., and to commonly owned Provisional Patent Application Ser. No. 60/602,370, filed Aug. 17, 2004, entitled Default Send-To Recipient For Mobile Phone Messaging,” invented by Benjamin K. Gibbs, both of which are incorporated by reference herein.

### BACKGROUND OF THE INVENTION

1. Field of the Invention

The present invention relates to a mobile communication system. More particularly, the present invention relates to a system and a method for sending a message to a default recipient.

2. Description of the Related Art

Recently, many mobile telephones, commonly referred to as a mobile camera telephone or a camera phone, are available that are equipped with a built-in camera module. A user of a camera phone can take a photograph and send the photograph to a family member and/or a friend using, for example, wireless email or a Multimedia Messaging Service (MMS). To identify a desired recipient of a photograph, the user selects a name or group of names from an address book stored in the camera phone, or manually enters an address for a desired recipient into the camera phone.

FIG. 1 is a flow diagram depicting a conventional process 100 for sending a photograph taken by a camera phone to a desired recipient. Additionally, FIG. 1 depicts a process of creating a Recent-Send-To list and adding a desired recipient to the Recent-Send-To list. At step 101, a user of a camera phone initiates the camera function by, for example, selection of the camera application from a menu or by actuating a camera function key or a camera shutter key. At step 102, the user takes a photograph by actuating a camera shutter key. At step 103, the user views the photograph on a display of the camera telephone and decides to send the picture to a particular recipient by manually selecting a send photograph function. If the user decides not to send the picture, the process is exited at this point.

At step 104, when the camera phone has a Recent-Send-To list functionality and a Recent-Send-To list has already been created, the process flows to step 105. If, at step 104, the camera phone does not have a Recent-Send-To list functionality or a Recent-Send-To list has not yet been created, flow proceeds to step 110.

At step 105, the camera phone displays the Recent-Send-To list to the user for selection of a desired recipient. At step 106, the user selects a desired recipient from the displayed Recent-Send-To list by scrolling through the list or, if the desired recipient is not contained in the Recent-Send-To list, the user might be prompted to select, for example, “OTHER.” Flow continues to step 107 where it is determined whether the user selected “OTHER.” If, at step 107, it is determined that “OTHER” has not been selected, flow continues to step 108 where, for example, the user actuates a SEND key to send a message containing the photograph to the desired recipient. At step 109, in response to actuation of the SEND key, the camera phone sends the message containing the photograph to the desired recipient.

If, at step 104, the camera phone does not have a Recent-Send-To list capability or a Recent-Send-To list has not yet been created, or at step 107, it is determined that “OTHER” has been selected, flow continues to step 110 where the user is prompted to manually enter an address for the intended recipient, such as an email address, telephone number or a Universal Resource Locator (URL). This information may also come from an address book or a contact information application on the camera phone. Flow continues to step 111 where, for example, the user actuates a SEND key to send a message containing the photograph to the desired recipient. Flow continues to step 112 wherein the camera phone stores the name and address of the desired recipient in the Recent-Send-To list. Flow continues to step 109 where, in response to actuation of the SEND key, the camera phone sends the message containing the photograph to the desired recipient.

Consequently, what is needed is a simplified technique for sending messages from a mobile telephone to a desired recipient.

### BRIEF SUMMARY OF THE INVENTION

The present invention provides a simplified technique for sending messages from a mobile telephone to a desired recipient.

The present invention provides a system and a method in which a message is sent from a mobile telephone to a default recipient. In one exemplary embodiment, the mobile telephone is a mobile camera telephone, and the message includes a photograph taken by the mobile camera telephone. The message could additionally or alternatively include text-based content, voice-based content, image-based content and/or video-based content. According to the present invention, a default recipient could be a preselected default recipient. Alternatively, the default recipient could be determined based on a most recent recipient of another message. As yet another alternative, the default recipient could be determined based on a recipient contained in a send-to list that has received a most number of messages. Still another alternative provides that the default recipient is determined in response to actuation of a selected key of the mobile telephone that corresponds to the default recipient. The default recipient is displayed to a user of the mobile telephone before the message is sent to the default recipient when the user affirmatively accepts the default recipient or after a predetermined amount of time has elapsed after the default recipient has been displayed to the user.

### BRIEF DESCRIPTION OF THE DRAWINGS

The present invention is illustrated by way of example and not by limitation in the accompanying figures in which like reference numerals indicate similar elements and in which:

FIG. 1 is a flow diagram depicting a conventional process for sending a photograph taken by a camera phone to a desired recipient;

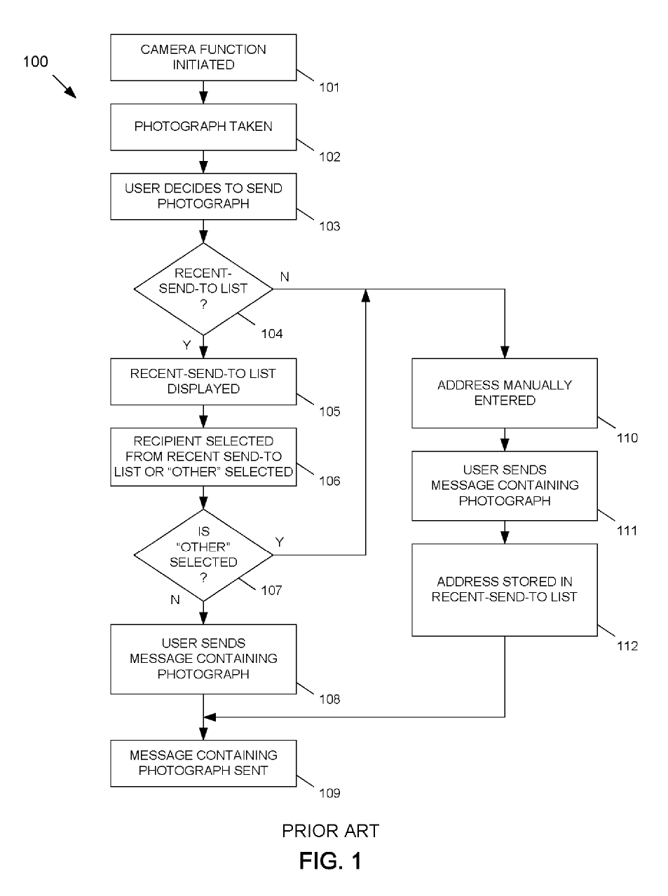

FIG. 2 depicts a functional block diagram of a mobile camera telephone that is suitable for use with the present invention;

FIG. 3 depicts a flow diagram for a first exemplary embodiment of a method for sending a photograph taken by a mobile camera telephone to a recipient according to the present invention; and

FIG. 4 depicts a flow diagram for a second exemplary embodiment of a method for sending a photograph taken by a mobile camera telephone to a recipient according to the present invention.

### DETAILED DESCRIPTION OF THE INVENTION

The present invention allows a user to repetitively send text-based messages, voice-based messages, video-based messages, image-based messages and/or photographic-based messages (herein collectively referred to as “messages” or a “message”) to the same recipient, referred to herein as a default recipient. In particular, one exemplary embodiment of the present invention automatically provides a default recipient for all messages created on a mobile telephone and/or photographs taken by the mobile telephone based on a history of previous message recipients, thereby simplifying the process and minimizing the number of keystrokes required for selecting a desired recipient of the message and/or photograph. In one exemplary embodiment of the present invention, a user of the mobile telephone could preset the default recipient. Alternatively, the default recipient could be the last recipient to whom the user sent a message and/or a photograph. As yet another alternative, the default recipient could be the recipient of the most messages and/or photographs. Further, the present invention can be used for sending content, such as text-based content, voice-based content, image-based content, photographic-based content and/or video-based content, that is stored on a mobile telephone to a default recipient.

The present invention also provides that a message and/or photograph is automatically sent to a default recipient after a user has created the message and/or taken the photograph without requiring any further keystrokes, or clicks. Before a message and/or photograph is sent to a default recipient, the default recipient is presented to a user of the mobile telephone for confirmation before the message and/or photograph is sent to the default recipient.

While the following description of the present invention focuses primarily on sending a photograph to a desired recipient from a camera phone, it should be understood that the present invention is not so limited and is equally applicable to a technique for sending a message alternatively or additionally containing text-based content, a voice-based content, image-based content and/or video-based content from a mobile telephone to a desired recipient. Additionally, while the following description refers to a single default recipient or a single desired recipient, it should be understood that the present invention is applicable to multiple default recipients and/or multiple desired recipients.

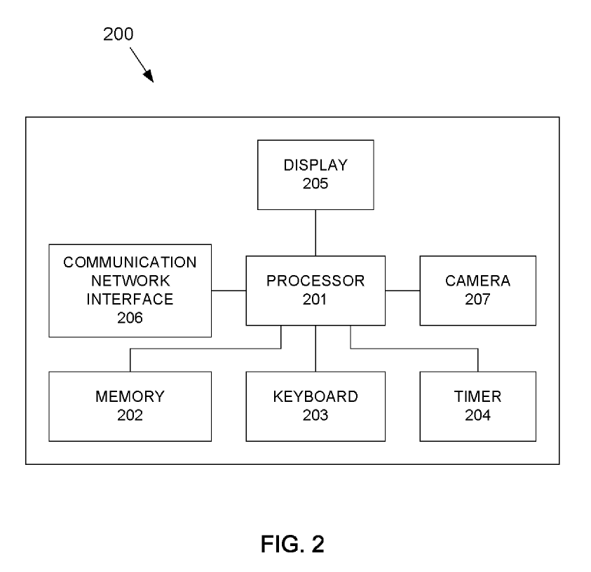

FIG. 2 depicts a functional block diagram of a mobile camera telephone 200 that is suitable for use with the present invention. Mobile camera telephone 200 includes a processor 201, a memory 202, a keyboard 203, a timer 204, a display 205, a communication network interface 206 and a camera 207. Memory 202 stores information, such as, but not limited to, programs and applications that are executable by processor 201, configuration information, an address book, a Recent-Sent-To list, and a gallery of photographs. Keyboard 203 can be used for entering a dialed number, configuration information, information forming the address book and text information forming a message. Display 205 displays information and provides a visual interface for a user of the mobile camera telephone. Communication network interface 206 provides a wireless interface in a well-known manner to a communications network, such as a cellular network or a personal communication system (PCS). Camera 207 provides camera-type functionality in a well-known manner.

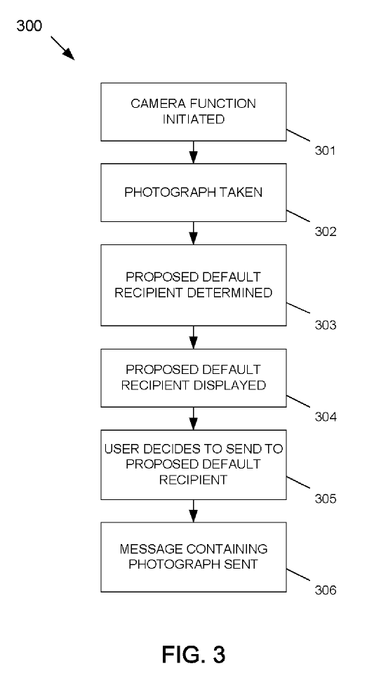

FIG. 3 depicts a flow diagram 300 for a first exemplary embodiment of a method for sending a photograph taken by a camera phone to a recipient according to the present invention. At step 301, a user of a camera phone initiates the camera function by, for example, selection of the camera application from a menu or by actuating a camera function key that is, for example, part of keyboard 203 or a camera shutter key (not shown) that is functionally associated with camera 207. At step 302, the user takes a photograph by actuating the camera shutter key and the photograph is displayed on display 205. At step 303, a proposed default recipient is determined by, for example, the proposed default recipient being a preselected default recipient, that is, a default recipient that has been selected by the user to be the default recipient. Alternatively, the default recipient could be selected based on the most recent recipient of a photograph contained in an address book or a Recent-Send-To list. As yet another alternative, the proposed default recipient could be determined based on being the most recent recipient of a message sent from the camera phone. As still another alternative, the proposed default recipient could be determined based on the most photographs sent to a recipient out of the total number of photographs sent from the camera phone. For example, if a total of 25 photographs have been sent from the camera phone and 15 of the 25 have been sent to one particular recipient, the recipient receiving the 15 photographs would be determined to be the proposed default recipient. As still another alternative, the proposed default recipient could be determined based on the most photographs sent to a recipient out of the total number of photographs sent from the camera phone over a defined period of time, such as the last month.

At step 304, the proposed default recipient is displayed on display 205. Alternatively, at step 302, the proposed default recipient is not displayed on display 205. At step 305, the user decides to send the picture to the proposed default recipient and manually actuates, for example, a SEND key on keyboard 203 to send a message containing the photograph to the intended recipient. If the user decides not to send the picture, the process is exited at this point. At step 306, in response to actuation of the SEND key, the camera phone sends the message containing the photograph to the proposed default recipient.

Alternatively, at step 305, a user could “long” press (i.e., continuously press), for example, the SEND key for sending the photograph to the default recipient. As yet another alternative, at step 305, a user could select a desired recipient that is different from the proposed default recipient by “short” actuating (i.e., normally pressing) the SEND key on keyboard 203 for obtaining a prompt to enter a desired recipient. As still another alternative, a user could “long” actuate a selected key of keyboard 203 that has been associated with the desired recipient in a manner that is similar to a speed-dialing association. Flow would continue to step 306 where the camera phone automatically sends a message containing the photograph in response to the “long” actuation of the selected key.

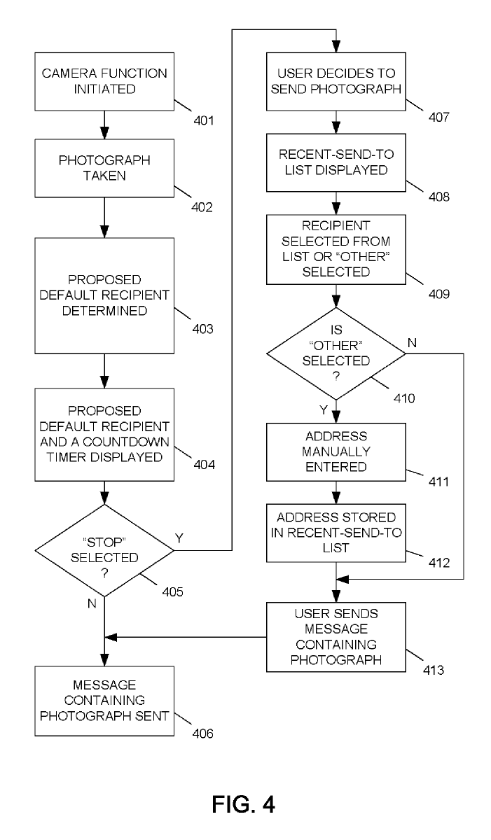

FIG. 4 depicts a flow diagram 400 for a second exemplary embodiment of a method for sending a photograph taken by a camera phone to a recipient according to the present invention. At step 401, a user of a camera phone initiates the camera function by, for example, selection of the camera application from a menu or by actuating a camera function key that is, for example, part of keyboard 203 or a camera shutter key that is functionally associated with camera 207. At step 402, the user takes a photograph by actuating the camera shutter key and the photograph is displayed on display 205. At step 403, a proposed default recipient is determined by, for example, the proposed default recipient being a predetermined default recipient. Alternatively, the default recipient could be selected based on the most recent recipient of a photograph contained in an address book or a Recent-Send-To list. As yet another alternative, the proposed default recipient could be determined based on being the most recent recipient of a message sent from the camera phone. As still another alternative, the proposed default recipient could be determined based on the most photographs sent to a recipient out of the total number of photographs sent from the camera phone. As still another alternative, the proposed default recipient could be determined based on the most photographs sent to a recipient out of the total number of photographs sent from the camera phone over a defined period of time, such as the last month.

At step 404, the proposed default recipient is displayed on display 205 along with a “STOP” command. Additionally, timer 204 is initialized to a predetermined value such as five seconds and display 205 could display, for example, “Sending to Fred in 5 seconds,” followed by “Sending to Fred in 4 seconds,” etc. If, at step 405, the user selects the “STOP” command, flow continues to step 407. If, at step 405, the user does not select the “STOP” command, and when the predetermined time has expired, the photograph is sent to the proposed default recipient at step 406.

When the user selects the “STOP” command at step 405, the process flows to step 407 where the user decides whether to send the photograph to a recipient and a Recent-Send-To list is displayed on display 205 at step 408. (If the user decides not to send the picture, the process is exited at this point.) At step 409, the user selects a desired recipient, or if the desired recipient is not contained in the Recent-Send-To list, the user might be prompted to select, for example, “OTHER.” If, at step 410, it is determined that the user selected “OTHER”, flow continues to step 411, otherwise flow continues to step 413. At step 411, the address, such as an email address, telephone number or a Universal Resource Locator (URL), for the desired recipient is manually entered through keyboard 203 and displayed on display 205. Alternatively, a user can select a desired recipient by “long” actuating (i.e., continuously presses) a selected key of keyboard 203 that has been associated with the desired recipient. At step 412, the address for the desired recipient is stored in a Recent-Send-To list in memory 202. Flow continues to step 413.

At step 413, the user manually actuates, for example, a SEND key on keyboard 203 to send a message containing the photograph to the desired recipient. Flow continues to step 406, where, in response to actuation of the SEND key, the mobile camera telephone sends the message containing the photograph to the desired recipient.

Alternatively, at step 409, a user could select a desired recipient that is different from the proposed default recipient by “long” actuating (i.e., continuously pressing) a selected key of keyboard 203 that has been associated with the desired recipient. Flow would continue directly to step 406 where the camera phone automatically sends a message containing the photograph in response to the “long” actuation of the selected key.

The present invention can be used for sending content, such as photographic-based content and/or video-based content, that is stored on a mobile telephone to a default recipient. In particular, when a user navigates to a media gallery stored on the camera phone and selects a particular photograph to view, a proposed default recipient is determined, similar to step 303 in FIG. 3 or step 403 in FIG. 4. Subsequent steps would be similar to steps 304-306 or 404-413 depending on the embodiment of the present invention configured in the mobile telephone.

Although the foregoing invention has been described in some detail for purposes of clarity of understanding, it will be apparent that certain changes and modifications may be practiced that are within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method of sending a message from a mobile telephone to a recipient, the method comprising:
creating a message; and
determining a default recipient for the message.

2. The method according to claim 1, further comprising sending the message to the default recipient.

3. The method according to claim 2, further comprising displaying the default recipient to a user of the mobile telephone before sending the message to the default recipient.

4. The method according to claim 2, wherein sending the message to the default recipient occurs after a predetermined amount of time after the default recipient has been displayed to a user.

5. The method according to claim 1, wherein determining the default recipient determines a preselected default recipient.

6. The method according to claim 1, wherein determining the default recipient includes determining the default recipient based on a most recent recipient of another message.

7. The method according to claim 1, wherein determining the default recipient includes determining the default recipient based on a recipient contained in a send-to list that has received a most number of messages.

8. The method according to claim 1, wherein determining the default recipient includes selecting the default recipient in response to actuation of a selected key of the mobile telephone that corresponds to the default recipient.

9. The method according to claim 1, wherein the message includes text-based content.

10. The method according to claim 1, wherein the message includes voice-based content.

11. The method according to claim 1, wherein the message includes image-based content.

12. The method according to claim 1, wherein the mobile telephone is a mobile camera telephone, and
wherein the message includes a photograph taken by the mobile camera telephone.

13. The method according to claim 1, wherein the mobile telephone is a mobile camera telephone, and
wherein the message includes video-based content taken by the mobile camera telephone.

14. A mobile telephone, comprising:
a user interface receiving inputs from a user; and
a processor coupled to the user interface, the processor receiving a message through the user interface and
determining a default recipient for the message.

15. The mobile telephone according to claim 14, wherein the processor sends the message to the default recipient.

16. The mobile telephone according to claim 15, further comprising a display displaying the default recipient to a user of the mobile telephone.

17. The mobile telephone according to claim 15, wherein the process sends the message to the default recipient after a predetermined amount of time after the default recipient has been displayed to a user.

18. The mobile telephone according to claim 14, wherein the default recipient is a preselected default recipient.

19. The mobile telephone according to claim 14, wherein the processor determines the default recipient based on a most recent recipient of another message.

20. The mobile telephone according to claim 14, wherein the processor determines the default recipient based on a recipient contained in a send-to list that has received a most number of messages.

21. The mobile telephone according to claim 14, wherein the processor determines the default recipient in response to actuation of a selected key of the user interface that corresponds to the default recipient.

22. The mobile telephone according to claim 14, wherein the message includes text-based content.

23. The mobile telephone according to claim 14, wherein the message includes voice-based content.

24. The mobile telephone according to claim 14, wherein the message includes image-based content.

25. The mobile telephone according to claim 14, wherein the mobile telephone is a mobile camera telephone, and
wherein the message includes a photograph taken by the mobile camera telephone.

26. The mobile telephone according to claim 14, wherein the mobile telephone is a mobile camera telephone, and
wherein the message includes video-based content taken by the mobile camera telephone.
